(19) United States
(12) Patent Application Publication
(10) Pub. No.: US 2016/0096542 A1
(43) Pub. Date: Apr. 7, 2016

(54) Auxilary Cart Basket Device

(71) Applicant: Bill Fukushima, Los Angeles, CA (US)

(72) Inventor: Bill Fukushima, Los Angeles, CA (US)

(21) Appl. No.: 14/504,884

(22) Filed: Oct. 2, 2014

(51) Int. Cl. B62B 5/00

(52) U.S. Cl. CPC B62B 5/00

(57) ABSTRACT

An auxiliary cart basket device adds an auxiliary basket to a shopping cart. The device includes a basket comprising a bottom wall, a pair of end walls, and a pair of side walls coupled to and extending between the end walls. A hook is coupled to the basket. The hook extends laterally outward relative to a first one of the side walls of the basket. A brace is coupled to and extends laterally outward from the first one of the side walls of the basket. The brace is vertically offset from the hook wherein the brace is configured for abutting a shopping cart to support the basket in a level position when the hook is engaged to a handle of the shopping cart.

### BACKGROUND OF THE DISCLOSURE

1. Field of the Disclosure

The disclosure relates to basket devices and more particularly pertains to a new basket device for adding an auxiliary basket to a shopping cart.

2. Summary of the Disclosure

An embodiment of the disclosure meets the needs presented above by generally comprising a basket comprising a bottom wall, a pair of end walls, and a pair of side walls coupled to and extending between the end walls. A hook is coupled to the basket. The hook extends laterally outward relative to a first one of the side walls of the basket.

A brace is coupled to and extends laterally outward from the first one of the side walls of the basket. The brace is vertically offset from the hook wherein the brace is configured for abutting a shopping cart to support the basket in a level position when the hook is engaged to a handle of the shopping cart.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a auxiliary cart basket device according to an embodiment of the disclosure.

FIG. 2 is a top rear side perspective view of an embodiment of the disclosure.

FIG. 3 is a top view of an embodiment of the disclosure.

FIG. 4 is a rear view of an embodiment of the disclosure.

FIG. 5 is a side view of an embodiment of the disclosure in use.

### DESCRIPTION OF THE PREFERRED EMBODIMENT

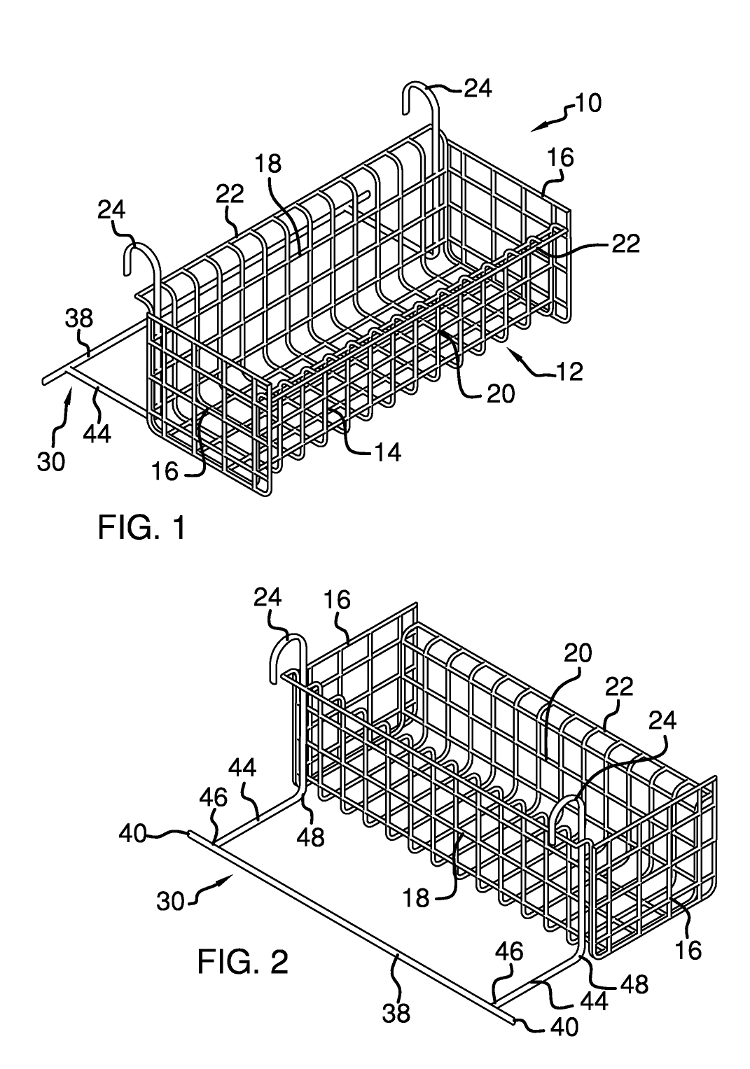

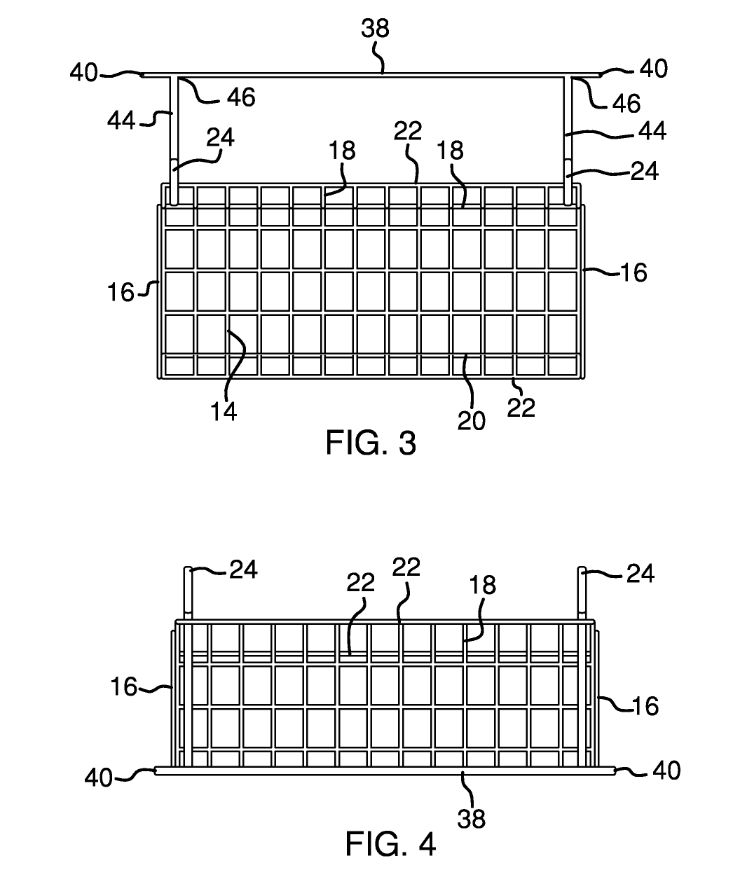

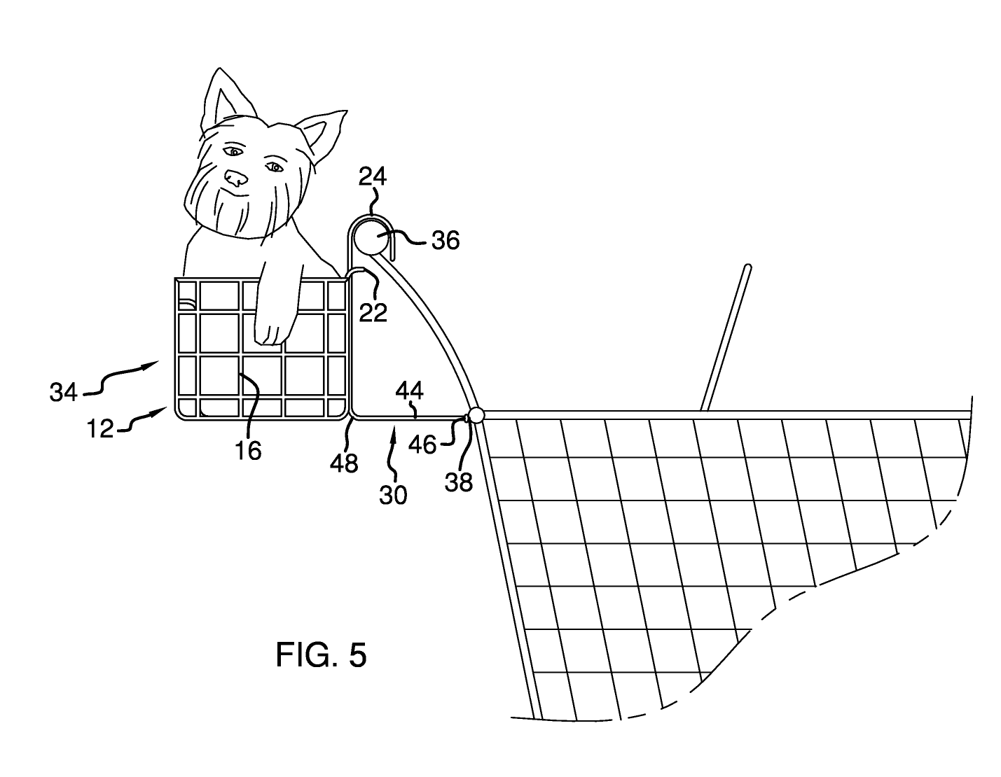

With reference now to the drawings, and in particular to FIGS. 1 through 5 thereof, a new basket device embodying the principles and concepts of an embodiment of the disclosure and generally designated by the reference numeral 10 will be described.

As best illustrated in FIGS. 1 through 5, the auxiliary cart basket device 10 generally comprises a basket 12 comprising a bottom wall 14, a pair of end walls 16, and a pair of side walls 18,20 coupled to and extending between the end walls 16. A respective top edge 22 of each side wall 18,20 of the basket 12 is flared outwardly. A first one of the side walls 18 of the basket 12 has a height greater than a second one of the side walls 20 of the basket 12. A hook 24 is coupled to the basket 12. The hook 24 extends laterally outward relative to the first one of the side walls 18 of the basket 12. The hook 24 is one of a pair of hooks 24 each having similar structure. Each hook 24 is positioned proximate a respective one of the end walls 16 of the basket 12.

A brace 30 is coupled to and extends laterally outward from the first one of the side walls 18 of the basket 12 under the hooks 24. The brace 30 is vertically offset from the hooks 24 wherein the brace 30 is configured for abutting a shopping cart 32 to support the basket 12 in a level position 34 when the hooks 24 are engaged to a handle 36 of the shopping cart 32. The brace 30 is coplanar with the bottom wall 14 of the basket 12. The brace 30 comprises an elongated bar 38 extending parallel to the first one of the side walls 18 of the basket 12. The brace 30 further comprises a pair of spacing bars 44 extending outwardly relative to the first one of the side walls 18 of the basket 12. Each of the spacing bars 44 has a distal end 46 relative to the basket 12. Each distal end 46 is inset from an associated end 40 of the elongated bar 38. Each spacing bar 44 is coupled to and extends from a bottom end 48 of a respective one of the hooks 24. Each of the end walls 16 of the basket 12 is inset relative to a respective one of the ends 40 of the elongated bar 38.

In use, the hooks 24 are set over the handle 36 of the shopping cart 32. The elongated bar 38 of the brace 30 pivots into contact with the shopping cart 32 to support the basket 12 in the level position. The basket 12 may then be used to support items. The basket 12 may be constructed of meshed wire or the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An auxiliary cart basket device comprising:
a basket comprising a bottom wall, a pair of end walls, and a pair of side walls coupled to and extending between said end walls, each of said side walls having an arcuate portion wherein a respective top edge of each said side wall of said basket is flared outwardly;
a hook coupled to said basket, said hook extending laterally outward relative to a first one of said side walls of said basket; and
a brace, said brace being coupled to and extending laterally outward from said first one of said side walls of said basket, said brace being vertically offset from said hook wherein said brace is configured for abutting a shopping cart to support said basket in a level position when said hook is engaged to a handle of the shopping cart, said brace comprising an elongated bar extending parallel to said first one of said side walls of said basket and a pair of spacing bars extending outwardly relative to said first one of said side walls of said basket, said brace being planar and perpendicular to said basket.

2. The device of claim 1, further comprising said brace being coplanar with said bottom wall of said basket.

3. (canceled)

4. The device of claim 1, further comprising said first one of said side walls of said basket having a height greater than a second one of said side walls of said basket.

5. The device of claim 1, further comprising said hook being one of a pair of said hooks, each said hook being positioned proximate a respective one of said end walls of said basket.

6. (canceled)

7. The device of claim 6, further comprising each of said spacing bars having a distal end relative to said basket, each said distal end being inset from an associated end of said elongated bar.

8. The device of claim 7, further comprising each of said end walls of said basket being inset relative to a respective one of said ends of said elongated bar.

9. The device of claim 6, further comprising:
said hook being one of a pair of said hooks, each said hook being positioned proximate a respective one of said end walls of said basket; and
each said spacing bar being coupled to and extending from a bottom end of a respective one of said hooks.

10. An auxiliary cart basket device comprising:
a basket comprising a bottom wall, a pair of end walls, and a pair of side walls coupled to and extending between said end walls, each of said side walls having an arcuate portion wherein a respective top edge of each said side wall of said basket is flared outwardly, a first one of said side walls of said basket having a height greater than a second one of said side walls of said basket;
a hook coupled to said basket, said hook extending laterally outward relative to said first one of said side walls of said basket, said hook being one of a pair of said hooks, each said hook being positioned proximate a respective one of said end walls of said basket;
a brace, said brace being coupled to and extending laterally outward from said first one of said side walls of said basket, said brace being vertically offset from said hook wherein said brace is configured for abutting a shopping cart to support said basket in a level position when said hook is engaged to a handle of the shopping cart, said brace being coplanar with said bottom wall of said basket, said brace comprising an elongated bar having a pair of ends, said elongated bar extending parallel to said first one of said side walls of said basket, each of said end walls of said basket being inset relative to a respective one of said ends of said elongated bar, said brace further comprising a pair of spacing bars extending outwardly relative to said first one of said side walls of said basket, each of said spacing bars having a distal end relative to said basket, each said distal end being inset from an associated one of said ends of said elongated bar, each said spacing bar being coupled to and extending from a bottom end of a respective one of said hooks, said brace being planar and perpendicular to said basket.
